(19) United States
(12) Patent Application Publication
(10) Pub. No.: US 2015/0194740 A1
(43) Pub. Date: Jul. 9, 2015

(54) MULTI-CHANNEL MIMO ANTENNA APPARATUS USING MONOPOLE OR DIPOLE ANTENNA

(71) Applicant: Electronics and Telecommunications Research Institute, Daejeon (KR)

(72) Inventor: Jeong Ho JU, Daejeon (KR)

(21) Appl. No.: 14/583,285

(22) Filed: Dec. 26, 2014

(30) Foreign Application Priority Data
Jan. 3, 2014 (KR) 10-2014-0000893

(51) Int. Cl. H01Q 21/28; H01Q 9/16

(52) U.S. Cl. CPC H01Q 21/28; H01Q 9/16

(57) ABSTRACT

A monopole MIMO antenna apparatus using a monopole antenna or dipole antenna is provided. The antenna apparatus may include a first antenna device disposed at a side of a ground surface, a second antenna device disposed at another side of the ground surface and at least one parasitic antenna device spaced apart from the first antenna device and the second antenna device by a predetermined distance between the first antenna device and the second antenna device.

Priority to Korean patent application number 2014-0000893 filed on Jan. 3, 2014, the entire disclosure of which is incorporated by reference herein, is claimed.

### BACKGROUND OF THE INVENTION

1. Technical Field

Embodiments of the present invention relate to multi-channel MIMO (Multiple-Input Multiple-Output) antennas that may increase degree of isolation between antenna devices in a narrow space using a monopole antenna or dipole antenna.

2. Discussion of Related Art

In a wireless terrestrial/satellite communication system, data is typically transmitted or received on a predetermined frequency. For such purpose, an antenna is provided at an end of the wireless terrestrial/satellite system to perform signal transmission and reception. The antenna should be configured to be able to efficiently transmit and receive electromagnetic waves and accordingly intensive research and development on such antenna is underway.

As an example, Korean Patent Application Publication No. 10-2008-38031 (published on May 2, 2008), titled “multi-resonant antenna,” discloses an antenna enabling broad-band reception, including an antenna device unit, a plurality of power supply units supplying power to the antenna device unit, a parasitic element unit disposed in a dielectric region between a substrate on which an antenna circuit is disposed and the antenna element unit, a power supply switching unit selectively connecting any one of the plurality of power supply units to the antenna element unit so as to supply power to the antenna element unit, and a parasitic element switching unit controlling the parasitic element unit.

Meanwhile, the wireless terrestrial/satellite communication system includes frequency, polarization, space, and direction as essential resources. However, current growth of wireless communication services is depleting frequency resources that are most critical resources in wireless communications and as communication services are turning into broadband services, MIMO (Multiple-Input Multiple-Output) communication technology is inevitably required. The MIMO communication technology aims to increase communication capacity by sending multiple channels independent from each other using multiple antennas. However, a majority of wireless satellite communication/mobile communication terminals or relays/base station antennas for MIMO communication utilize a fixed polarization and beam pattern. The antenna architecture using such fixed polarization and beam pattern is not suitable for MIMO antenna structure for high-speed data transmission.

Further, saturation (depletion) of frequency resources in wireless communications is predicted to accelerate flexible application/utilization of new radio resources such as polarization, space, or direction (antenna beam pattern). Thus, next-generation MIMO antenna architectures should have a high degree of inter-antenna isolation and should be formed to allow the antenna beam pattern to comply with radio environments and system requirements. However, installation of a number of antennas in a limited space may cause mutual interference between the antennas due to the spatial limitation and deteriorates the degree of inter-antenna isolation. Such deterioration of the degree of isolation may affect the channel capacity in which data is transmitted, thus leading to a reduction in the amount of transmission. To address such problems, the distance between antennas may be left to be more than a half wavelength, and this is difficult to implement under spatial limitation.

### SUMMARY OF THE INVENTION

An object of the present invention is to provide a multi-channel MIMO antenna apparatus using a monopole or dipole antenna that may increase degree of isolation between antenna devices in a limited space.

According to an aspect of the present invention, an antenna apparatus may comprise a first antenna device disposed at a side of a ground surface, a second antenna device disposed at another side of the ground surface, and at least one parasitic antenna device spaced apart from the first antenna device and the second antenna device by a predetermined distance between the first antenna device and the second antenna device.

In an aspect, the first antenna device and the second antenna device may be power supply antennas, and the parasitic antenna device may be a non-power supply antenna.

In another aspect, the first antenna device and the second antenna device may be disposed to be symmetrical with each other with respect to the parasitic antenna device.

In still another aspect, the first antenna device, the second antenna device, and the parasitic antenna device may be monopole antennas or dipole antennas.

In yet still another aspect, the first antenna device, the second antenna device, and the parasitic antenna device have the same capability.

In yet still another aspect, lengths of the first antenna device, the second antenna device, and the parasitic antenna device may be determined depending on a wavelength corresponding to a center frequency of an operation frequency band of the antenna devices.

In yet still another aspect, the lengths of the first antenna device, the second antenna device, and the parasitic antenna device correspond to 1/4 of the wavelength corresponding to the center frequency.

In yet still another aspect, interference between the second antenna device and the first antenna device may be canceled out by an induced current generated by a coupling between the first antenna device and the parasitic antenna device.

In yet still another aspect, the first antenna device and the second antenna device have a microstrip line and a via inserted therein.

According to another aspect of the present invention, an antenna apparatus may comprise two or more antenna devices, and at least one parasitic antenna device spaced apart from the antenna devices between the antenna devices, wherein the antenna devices may be disposed to be symmetrical with each other with respect to the parasitic antenna device.

According to the present invention, an antenna apparatus includes a first antenna device disposed at a side of a ground surface, a second antenna device disposed at another side of the ground surface, and at least one parasitic antenna device spaced apart from the first antenna device and the second antenna device between the first antenna device and the second antenna device, leading to an increase in the degree of isolation between the antenna devices in a limited space.

### BRIEF DESCRIPTION OF DRAWINGS

FIG. 1 is a perspective view illustrating a two-port monopole MIMO antenna apparatus according to an embodiment of the present invention;

FIG. 2 is a perspective view illustrating a three-port monopole MIMO antenna apparatus according to an embodiment of the present invention;

FIGS. 3 and 4 are perspective views illustrating four-port monopole MIMO antenna apparatuses according to embodiments of the present invention;

FIGS. 5 and 6 are perspective views illustrating a single-band monopole antenna and a dual-band monopole antenna used in a monopole MIMO antenna apparatus according to the present invention;

FIG. 7 is a view illustrating a current flow in a four-port monopole MIMO antenna apparatus according to an embodiment of the present invention;

FIGS. 8 and 9 are graphs illustrating the reflection loss/degree of isolation of a four-port monopole MIMO antenna apparatus according to an embodiment of the present invention; and

FIG. 10 is a graph illustrating a radiation pattern of a four-port monopole MIMO antenna apparatus according to an embodiment of the present invention.

### DETAILED DESCRIPTION OF EMBODIMENTS

Hereinafter, embodiments of the present invention are described below in detail with reference to the accompanying drawings so that the embodiments can be easily practiced by one of ordinary skill in the art. However, various changes may be made without being limited thereto. What is irrelevant to the present invention was skipped from the description for clarity, and like reference denotations are used to refer to like or similar elements throughout the specification.

As used herein, when an element “includes” another element, the element may further have the other element unless stated otherwise. As used herein, the term “unit” denotes a unit of performing at least one function or operation and may be implemented in hardware, software, or a combination thereof.

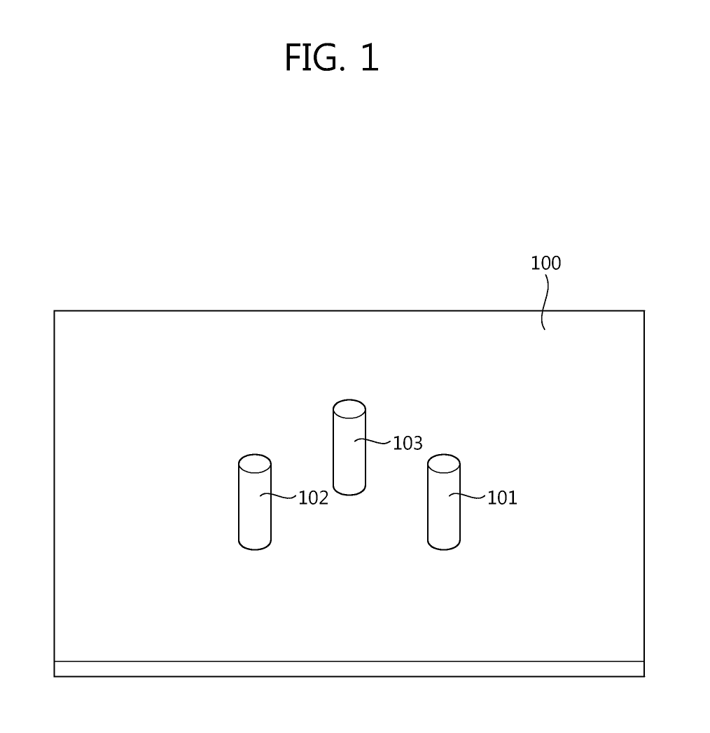

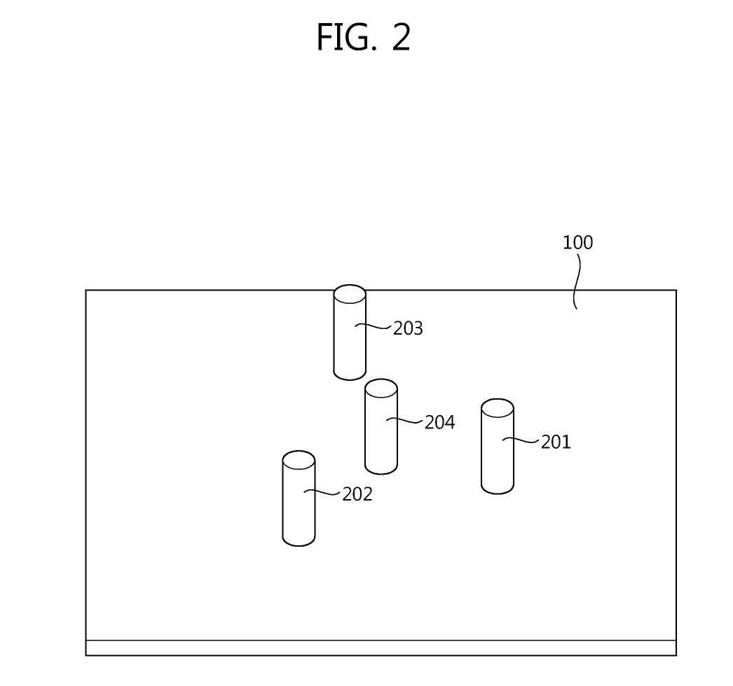

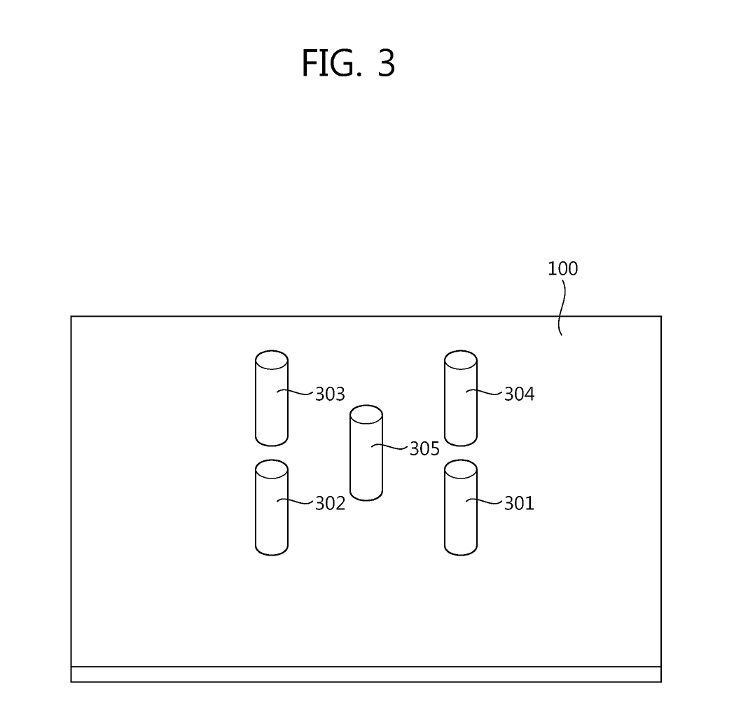

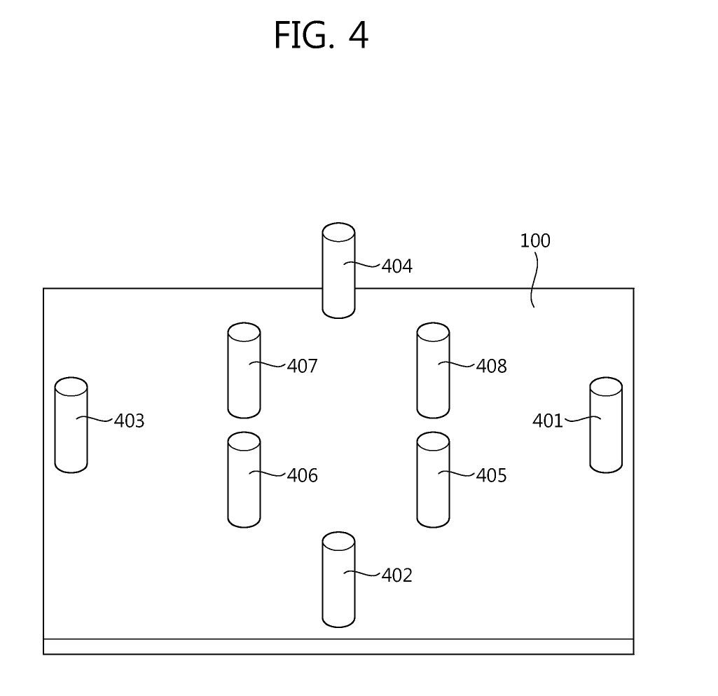

FIG. 1 is a perspective view illustrating a two-port monopole MIMO antenna apparatus according to an embodiment of the present invention. FIG. 2 is a perspective view illustrating a three-port monopole MIMO antenna apparatus according to an embodiment of the present invention. FIGS. 3 and 4 are perspective views illustrating four-port monopole MIMO antenna apparatuses according to embodiments of the present invention.

According to the present invention, a high-isolation MIMO (Multiple-Input Multiple-Output) antenna apparatus, as shown in FIGS. 1 to 4, includes a ground surface 100, power supply antenna devices 101, 102, 201, 202, 203, 301, 302, 303, and 304 disposed on the ground surface 100, and parasitic antenna devices 103, 204, 305, 405, 406, 407, and 408.

According to an embodiment of the present invention, the high-isolation MIMO antenna apparatus, as shown in FIG. 1, may include the first antenna device 101 positioned at a side of the ground surface 100, the second antenna device 102 positioned at the other side of the ground surface 100, and the parasitic antenna device 103 spaced apart from the first antenna device 101 and the second antenna device 102 therebetween and connected with the ground surface 100. Here, the first antenna device 101, the second antenna device 102, and the parasitic antenna device 103 may be monopole antennas or dipole antennas. Although in FIG. 1 the ground surface 100 is shaped as a rectangle, for example, the size and shape of the ground surface 100 may be varied as necessary. Further, although in FIG. 1, each antenna device 101, 102, or 103 is a cylindrical monopole antenna or dipole antenna, each antenna device 101, 102, or 103 may be any type of antenna irrespective of the presence or absence of the ground surface 100. By way of example, as each antenna device 101, 102, or 103, not only a dipole antenna or monopole antenna, but also other high-frequency antennas such as a patch antenna, a horn antenna, a parabolic antenna, a helical antenna, or a slot antenna, may be used as well.

Meanwhile, the first antenna device 101 and the second antenna device 102 may be power supply antennas, and the parasitic antenna device 103 may be a non-power supply antenna. Accordingly, the first antenna device 101 and the second antenna device 102 may be connected with a power supply unit (not shown). The first antenna device 101 and the second antenna device 102 may be formed alongside the parasitic antenna device 103 disposed on the ground surface 100 and may be positioned to be symmetrical to each other with respect to the parasitic antenna device 103. Accordingly, the first antenna device 101 is the same in capability (reflection loss) as the second antenna device 102.

Further, the length of the first antenna device 101, the second antenna device 102, and the parasitic antenna device 103 may be determined depending on the wavelength (λ) corresponding to a center frequency in an operation frequency band of the antenna device. As an example, the length of each antenna device 101, 102, and 103 may correspond to ¼ of the wavelength of the center frequency. The first antenna device 101 and the second antenna device 102 formed thus are connected with outside signal circuits, respectively, and receive their respective electrical signals to transmit electromagnetic waves or receive electromagnetic waves from the outside and may transfer to the signal circuits.

Meanwhile, when current I₁ is supplied to the first antenna device 101, induced currents −I₂₁ and −I₃₁ are primarily generated in the second antenna device 102 and the parasitic antenna device 103 by couplings between the antenna devices 101, 102, and 103. The induced currents −I₂₁ and −I₃₁ are reverse-proportional/proportional to the distance and magnitude of the current. The reason why the magnitude of the current has a negative value, the induced currents flow in an opposite direction of the power supply current. Current I₂₃ of any magnitude is secondarily generated in the second antenna device 102 by the induced current −I₂₁.

The reason why the current has a positive value, the current has been induced from the induced current −I₂₁. Accordingly, when current I₁ is supplied to the first antenna device 101, two induced currents −I₃₁ and I₂₃ are generated in the second antenna device 102 by the parasitic antenna device 103, and the two induced currents are summed in the second antenna device 102 (−I₃₁+I₂₃). Accordingly, interference between the first antenna device 101 and the second antenna device 102 is traded off by an induced current by a coupling between the first antenna device 101 and the parasitic antenna device 103, and the degree of isolation between the first antenna device 101 and the second antenna device 102 is increased. Further, the radiation pattern of the antenna devices is varied by the induced currents generated by the parasitic antenna device 103, thus generating a pattern diversity while allowing each antenna device 101 and 102 to have directivity. That is, a large amount of power is delivered to the power supply antenna, and radiation is carried out to the rear side of the parasitic antenna device 103 with a small amount of power.

As described above, since the parasitic antenna device 103 created in the MIMO antenna apparatus according to the present invention may re-induce a current induced in the first antenna device 101 to the second antenna device 102, the degree of isolation between the first antenna device 101 and the second antenna device 102 may be increased, and a pattern diversity may be implemented.

Meanwhile, although in FIG. 1 the MIMO antenna apparatus includes two antenna devices 101 and 102 and one parasitic antenna device 103, the MIMO antenna apparatus according to the present invention may include two or more antenna devices 201, 202, 203, 301, 302, 303, 304, 401, 402, 403, and 404 and at least one parasitic antenna device 204, 305, 405, 406, 407, and 408 spaced apart from the antenna devices between the antenna devices. Even in such case, the antenna devices may be positioned symmetrical with each other with respect to the parasitic antenna devices.

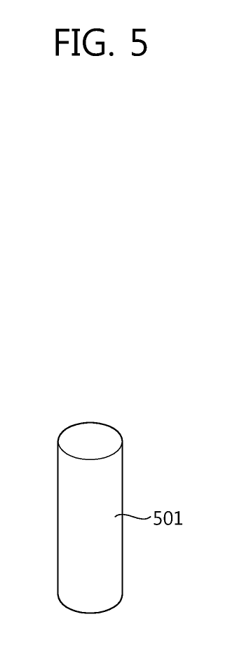

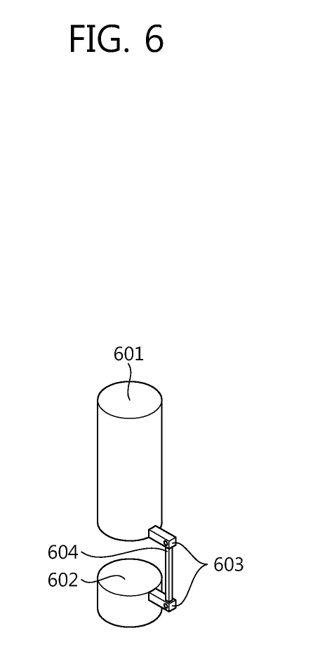

FIGS. 5 and 6 are perspective views illustrating a single-band monopole antenna and a dual-band monopole antenna used in a monopole MIMO antenna apparatus according to the present invention.

The antenna device 501 shown in FIG. 5 may be a monopole antenna operating in a single band and may have a length of ¼ of a wavelength (A) corresponding to the center frequency. Meanwhile, the antenna devices 601 and 602 shown in FIG. 6 may be monopole antennas operating in a dual band and may have a length of ¼ of a wavelength (λ) corresponding to the center frequency of low operation frequencies, with a microstrip line 603 and a via 604 positioned therebetween. The microstrip line 603 and the via 604 are electrically coupled with each other to have a band stop feature at a high operation frequency to stop signal flow and to have a band pass feature at a low operation frequency to enable signal flow. Thus, the monopole antenna shown in FIG. 6 operates in the monopole antennas 601+602 at a low operation frequency and operates only in the monopole antenna 602 at a high operation frequency, thus operating as a dual-band monopole antenna.

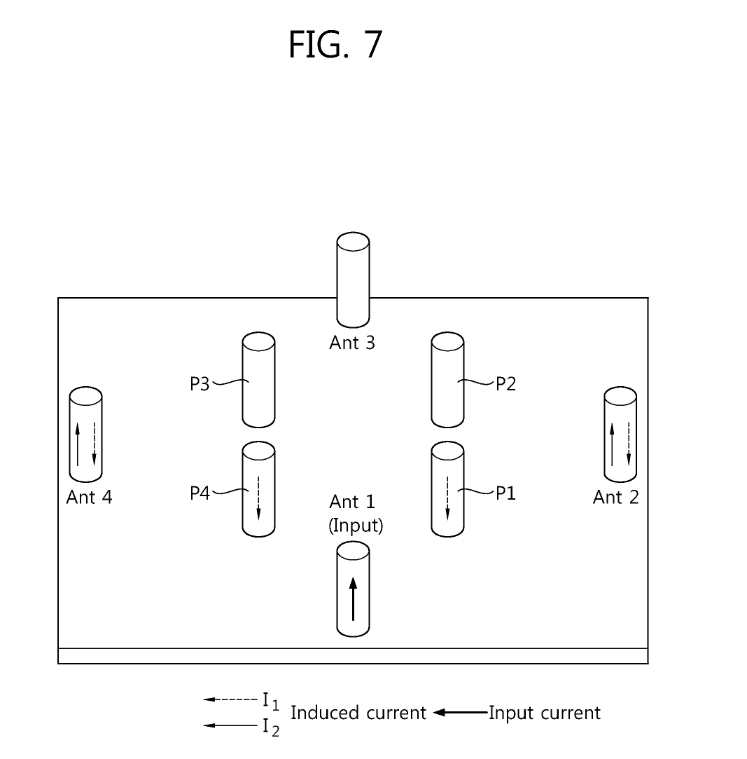

FIG. 7 is a view illustrating a current flow in a four-port monopole MIMO antenna apparatus according to an embodiment of the present invention. Hereinafter, a monopole MIMO antenna apparatus according to the present invention having a high degree of isolation is described with reference to FIG. 7.

When current is input to a first antenna device Ant1, an induced current I₁ flows through a second antenna device Ant2, a fourth antenna device Ant4, a first parasitic antenna device P1, and a fourth parasitic antenna device P4 in an opposite direction of the input current. Then, the first parasitic antenna device P1 and the fourth parasitic antenna device P4 play a role as a secondary generation source, allowing an additional induced current I₂ to flow through the second antenna device Ant2 and the fourth antenna device Ant4 in an opposite direction of the induced current I₁. Accordingly, the induced currents I₁ and I₂ are cancelled out in the second antenna device Ant2 and the fourth antenna device Ant4, thus increasing the degree of isolation. Additionally, since the parasitic antenna devices also serve as reflectors, gain and rear radiation characteristics are enhanced.

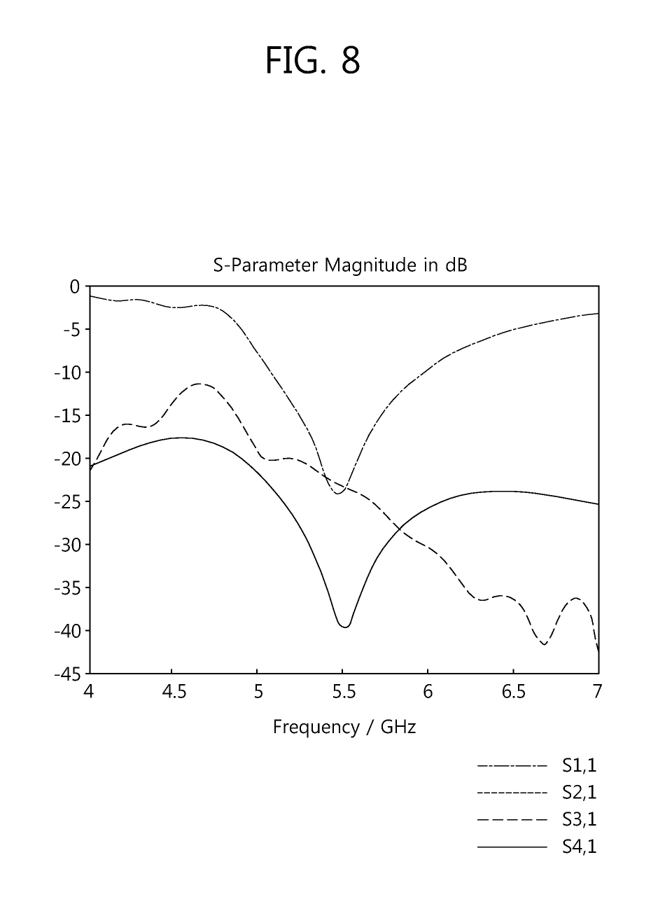

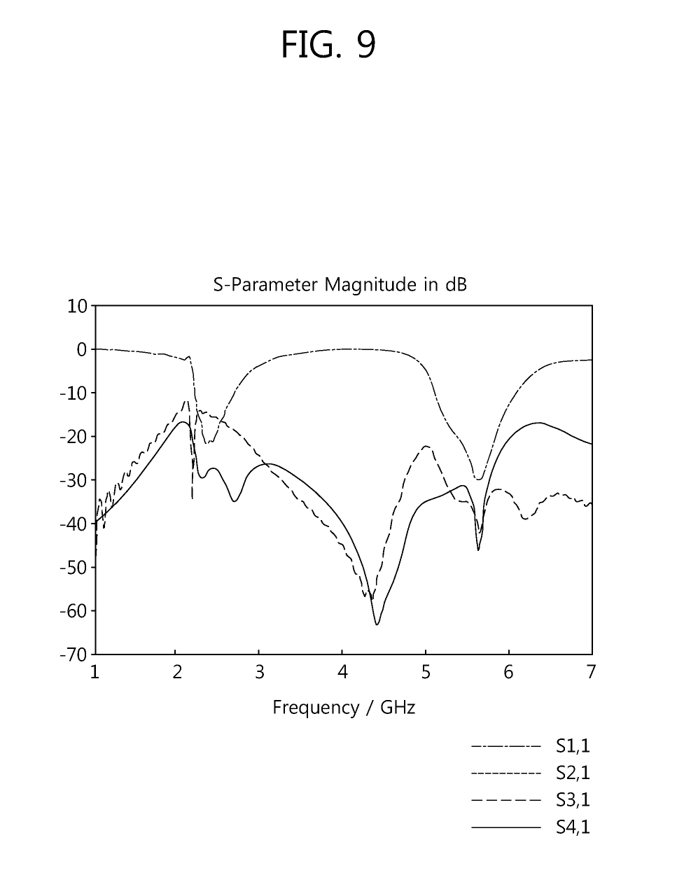

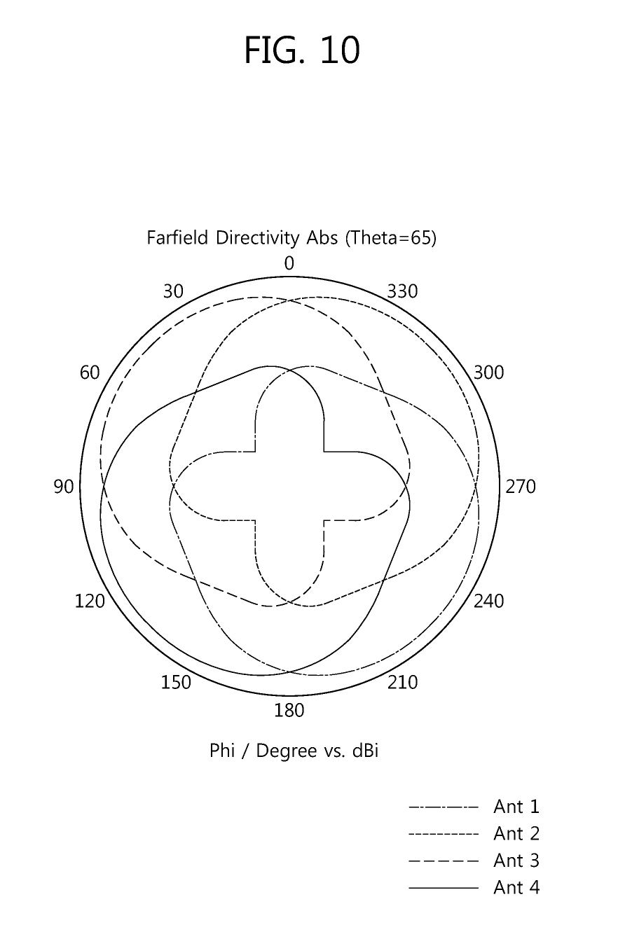

FIGS. 8 and 9 are graphs illustrating the reflection loss/degree of isolation of a four-port monopole MIMO antenna apparatus according to an embodiment of the present invention, and FIG. 10 is a graph illustrating a radiation pattern of a four-port monopole MIMO antenna apparatus according to an embodiment of the present invention.

FIG. 8 shows the reflection loss/degree of isolation when a single-band monopole antenna as shown in FIG. 5 applies to a four-port monopole MIMO antenna apparatus as shown in FIG. 4, and FIG. 9 shows the reflection loss/degree of isolation when a dual-band monopole antenna as shown in FIG. 6 applies to a four-port monopole MIMO antenna apparatus as shown in FIG. 4. Further, FIG. 10 shows the reflection pattern of a four-port monopole MIMO antenna apparatus as shown in FIG. 4.

As such, a monopole MIMO antenna apparatus according to the present invention may increase the degree of isolation between antenna devices through an induced current generated by a coupling between a power supply antenna device and a parasitic antenna device and may offer pattern diversity capability. Further, the degree of isolation between antennas and radiation pattern capability may be adjusted by the distance between the power supply antenna device and the parasitic antenna device and the length of the parasitic antenna device. Accordingly, the monopole MIMO antenna apparatus according to the present invention may be implemented in a narrow space and may be applicable to an MIMO system.

Although the present invention has been shown and described above in connection with embodiments thereof, it will be understood by those of ordinary skill in the art that various changes in form and detail may be made thereto without departing from the scope of the present invention defined by the following claims.

What is claimed is:

1. An antenna apparatus, comprising:
a first antenna device disposed at a side of a ground surface;
a second antenna device disposed at another side of the ground surface; and
at least one parasitic antenna device spaced apart from the first antenna device and the second antenna device by a predetermined distance between the first antenna device and the second antenna device.

2. The antenna apparatus of claim 1, wherein the first antenna device and the second antenna device are power supply antennas, and the parasitic antenna device is a non-power supply antenna.

3. The antenna apparatus of claim 1, wherein the first antenna device and the second antenna device are disposed to be symmetrical with each other with respect to the parasitic antenna device.

4. The antenna apparatus of claim 1, wherein the first antenna device, the second antenna device, and the parasitic antenna device are monopole antennas or dipole antennas.

5. The antenna apparatus of claim 1, wherein the first antenna device, the second antenna device, and the parasitic antenna device have the same capability.

6. The antenna apparatus of claim 1, wherein lengths of the first antenna device, the second antenna device, and the parasitic antenna device are determined depending on a wavelength corresponding to a center frequency of an operation frequency band of the antenna devices.

7. The antenna apparatus of claim 6, wherein the lengths of the first antenna device, the second antenna device, and the parasitic antenna device correspond to ¼ of the wavelength corresponding to the center frequency.

8. The antenna apparatus of claim 1, wherein interference between the second antenna device and the first antenna device is canceled out by an induced current generated by a coupling between the first antenna device and the parasitic antenna device.

9. The antenna apparatus of claim 1, wherein the first antenna device and the second antenna device have a microstrip line and a via inserted therein.

10. An antenna apparatus, comprising:
two or more antenna devices; and
at least one parasitic antenna device spaced apart from the antenna devices between the antenna devices, wherein the antenna devices are disposed to be symmetrical with each other with respect to the parasitic antenna device.

11. The antenna apparatus of claim 10, wherein the antenna devices are power supply antennas, and the parasitic antenna device is a non-power supply antenna.

12. The antenna apparatus of claim 10, wherein the antenna devices are disposed to be symmetrical with each other with respect to the parasitic antenna device.

13. The antenna apparatus of claim 10, wherein the antenna devices and the parasitic antenna device are monopole antennas or dipole antennas.

14. The antenna apparatus of claim 10, wherein the antenna devices and the parasitic antenna device have the same capability.

15. The antenna apparatus of claim 10, wherein lengths of the antenna devices and the parasitic antenna device are determined depending on a wavelength corresponding to a center frequency of an operation frequency band of the antenna devices.

16. The antenna apparatus of claim 15, wherein the lengths of the antenna devices and the parasitic antenna device correspond to ¼ of the wavelength corresponding to the center frequency.

17. The antenna apparatus of claim 10, wherein interference between the antenna devices is canceled out by an induced current generated by a coupling between the antenna devices and the parasitic antenna device.

18. The antenna apparatus of claim 10, wherein the antenna devices have a microstrip line and a via inserted therein.
